(19) United States
(12) Patent Application Publication
(10) Pub. No.: US 2005/0018661 A1
(43) Pub. Date: Jan. 27, 2005

(54) Methods and systems to process packet and non-packet data

(75) Inventor: Paul Kelley, Concord, MA (US)

Correspondence Address: FOLEY HOAG, LLP;PATENT GROUP, WORLD TRADE CENTER WEST, 155 SEAPORT BLVD, BOSTON, MA, 02110, US

(73) Assignee: Seranoa Networks, Inc., Boxborough, MA (US)

(21) Appl. No.: 10/897,957

(22) Filed: Jul. 23, 2004

Related U.S. Application Data
(60) Provisional application No. 60/489,319, filed on Jul. 23, 2003.

(51) Int. Cl. H04L 12/50; H04Q 11/00; H04L 12/66

(52) U.S. Cl. 370/352

(57) ABSTRACT

Disclosed are methods, systems, and processor programs for receiving at least one channelized T3 line, where the channelized T3 line is based on at least one communications line including packet data and/or non-packet data from at least one end user, identifying Digital Signal Zero (DS0) signals that include the packet data and DS0 signals that include the non-packet data, cross-connecting the non-packet data to at least one channelized line, and, transmitting at least some of the packet data to at least one network processor.

### CLAIM OF PRIORITY

This application claims priority to U.S. Ser. No. 60/489,319, and filed on Jul. 23, 2003, naming Paul Kelley as inventors, the contents of which are herein incorporated by reference in their entirety.

### BACKGROUND

(1) Field

The disclosed methods and systems relate generally to data communications, and more particularly to methods and systems for processing data at central office.

(2) Description of Relevant Art

In current communications systems, protocol data units (e.g., Internet Protocol (IP) packet data, etc.) and/or non-packet data (e.g., TDM voice data) can be communicated to a central office, where a central office (CO) can be understood herein to be a common carrier switching center in which trunks and loops (e.g., to homes, businesses, etc.) are terminated and/or switched. The connections to the central office can thus include analog data, TDM voice, etc. (collectively referred to herein as “non-packet data”) and/or digital data (e.g., packet data, including voice-over-IP (VoIP), collectively referred to herein as “packet data” and/or “protocol data units”), using a variety of connection media (e.g., twisted pair, fiber, radio) and/or protocols (e.g., ISDN, SONET, etc.). T1 connections are common connections to a central office, providing 24 multiplexed channels along, for example, a twisted pair connection, with each channel having a 64K bits per second transmission rate to achieve an effective transmission rate of 1.544 bits per second. Accordingly, non-packet data and/or packet data can be transmitted using a T1 line with, in a majority of the cases, a significant amount of the T1 line bandwidth (e.g., DS0 signals) empty and/or unutilized.

Generally, T1 connections to a central office interface to a multiplexer such as an M13 multiplexer, which transport data from up to 28 T1 connections to a channelized T3 signal, thereby replicating the empty/unutilized bandwidth (e.g., DS0 signals) from each of the T1 lines to the T3 line. The T3 signal can thus interface (e.g., Fiber using OC48) to one or more other central offices, and/or to a point-of-presence (PoP) server(s) that can include interfaces to a router and hence the Internet, switches to the Public Switched Telephone Network (PSTN), etc. Unfortunately, because the T3 line/signal inherits the unutilized/underutilized T1 line, which includes the empty DS0s, the T3 signal received at the PoP server(s) is also generally underutilized, with some estimates indicating that only twenty to thirty percent, or less, of the usable bandwidth of such T3 connection is being utilized.

Because operating expenses associated with a T3 line can be significant, a reduction in the number of T3 lines operated by an organization can provide equally significant cost and/or operating expense savings.

### SUMMARY

Disclosed are methods, systems, and processor programs, which include receiving a channelized T3 line(s), where the channelized T3 line(s) is based on at least one communications line including packet data and/or non-packet data from an end user(s), identifying Digital Signal Zero (DS0) signals that include the packet data and DS0 signals that include the non-packet data, cross-connecting the non-packet data to a channelized line(s), and, transmitting at least some of the packet data to a network processor(s). The network processor(s) can statistically multiplex the packet data, although in some embodiments, the statistical multiplexing can be performed by another device such as a multiplexer. The network processor(s) can transmit the statistically multiplexed packet data using a clear channel line(s) and/or multilink bundle(s) that can be a T3 line(s), where one (or more) of such T3 lines can be the same T3 line that includes the cross-connected data. The clear channel line(s) can include SONET and/or ETHERNET, including but not limited to Gigabit ETHERNET. The clear channel line(s) can include a multilink bundle.

The disclosed methods and systems can also allow for cross-connecting packet data to a T1 line, for example, to a single T1 line. The packet data can include IP data, concatenated DS0 FR data, IP Packet data, and/or concatenated DS0 ATM cell data. In one embodiment, the disclosed methods and systems can allow for a configuration that identifies less than twenty-five DS0s having at least one of concatenated FR data and ATM data, and, cross-connects the identified DS0s to a single T1 line.

Further, as provided herein, the channelized line(s) which can include the non-packet data, can be a T3 line, and can include SONET. The channelized line can include a multilink bundle. Accordingly, in some embodiments, the cross-connected data and one or more multilink bundles (e.g., packet data) can reside on one or more T3 lines.

In identifying Digital Signal Zero (DS0) signals that include the packet data and DS0 signals that include the non-packet data, the methods and systems also identify empty DS0 signals, which are understood herein to be DS0 signals that contain neither packet data nor non-packet data. Such identification of DS0 signals can be based on a provisioning of an Integrated Access Device (IAD) that can be based, for example, at the premises of a subscriber(s) and/or end user(s). The aforementioned cross-connecting can thus be performed based on the provisioning, and using an interface such as Telecom Management Protocol (TL1) and/or Command Line Interface (CLI). In performing the cross-connecting, the methods and systems can preserve robbed-bit signaling.

In the disclosed methods and systems, the network processor(s) can identify a concatenated Point-to-Point Protocol (PPP), High-level Data Link Control (HDLC), Frame Relay (FR) and/or an Asynchronous Transfer Mode (ATM) group of DS0s, and, can map the concatenated group to a single T1 line. The network processor(s) can also statically map a protocol data unit (PDU) based on a Data Link Channel Identifier (DLCI) tag, a Virtual Local Area Network (VLAN) tag, and/or Multiprotocol Label Switching (MPLS) label. In some embodiments, the network processor(s) can receive a protocol data unit having a label, access data identifying a channel associated with the label, and, transmit the protocol data unit via the identified channel. The label can include an MPLS (Multi-Protocol Label Switching) label, a VLAN (Virtual Local Area Network) tag, and/or a GMPLS (Generalized MPLS) label. The label can be established with a network router, for example, by requesting a label for the messages transmitted from a downstream entity to the router.

In some embodiments, the network processor(s) can receive at least one input from a Gigabit ETHERNET line (GigE), and map the data on the GigE to the clear channel line(s) based on VLAN tags, for example, by multiplexing the data on the GigE with the packet data. Further, the network processor(s) can receives an input(s) from a Gigabit ETHERNET line (GigE), and, map the data on the GigE to a Frame Relay (FR) and/or Multilink FR (MLFR) bundle based on DLCI tags.

In some embodiments, the methods and systems can be performed at a central office (CO), and accordingly, the aforementioned receiving, identifying, cross-connecting, and transmitting can occur at a CO, while in other embodiments, the receiving, identifying, cross-connecting, and transmitting can occur at a point-of-presence (PoP) server.

Also disclosed is a system that includes a user interface to specify cross-connections of DS0 signals, at least one T3 line interface, the T3 line interface providing DS0 signals that include at least one of packet data and non-packet data from at least one end user, a cross-connector to cross-connect the specified DS0 signals to at least one channelized line, and, at least one network processor to receive the non-cross-connected DS0 signals. The network processor(s) can include processor instructions for statistically multiplexing the received data. The system can also include an Add/Drop multiplexer and/or an interface to an Add/Drop multiplexer.

In some embodiments, the disclosed system can include one or more ETHERNET interfaces. The user interface can include Telecom Management Protocol (TL1) and/or Command Line Interface (CLI). Further, the network processor(s) can include instructions to transmit the received data using at least one clear channel line, where the clear channel line(s) can include a T3 line. The T3 line can include, in some embodiments, the cross-connected data. The clear channel line(s) can include SONET and/or ETHERNET. The system can optionally include one or more routers.

Other objects and advantages will become apparent hereinafter in view of the specification and drawings.

### BRIEF DESCRIPTION OF THE DRAWINGS

FIG. 1 shows one system for processing packet and non-packet data;

FIG. 2 demonstrates an example T3 line and an example T1 line;

FIGS. 3A-3C illustrate three examples of modifying a central office (CO);

FIGS. 4A and 4B illustrate systems for using a WANport Remote device; and,

FIG. 5 demonstrates some features of a WANport Remote device.

### DESCRIPTION

To provide an overall understanding, certain illustrative embodiments will now be described; however, it will be understood by one of ordinary skill in the art that the systems and methods described herein can be adapted and modified to provide systems and methods for other suitable applications and that other additions and modifications can be made without departing from the scope of the systems and methods described herein.

Unless otherwise specified, the illustrated embodiments can be understood as providing exemplary features of varying detail of certain embodiments, and therefore, unless otherwise specified, features, components, modules, and/or aspects of the illustrations can be otherwise combined, separated, interchanged, and/or rearranged without departing from the disclosed systems or methods. Additionally, the shapes and sizes of components are also exemplary and unless otherwise specified, can be altered without affecting the scope of the disclosed and exemplary systems or methods of the present disclosure.

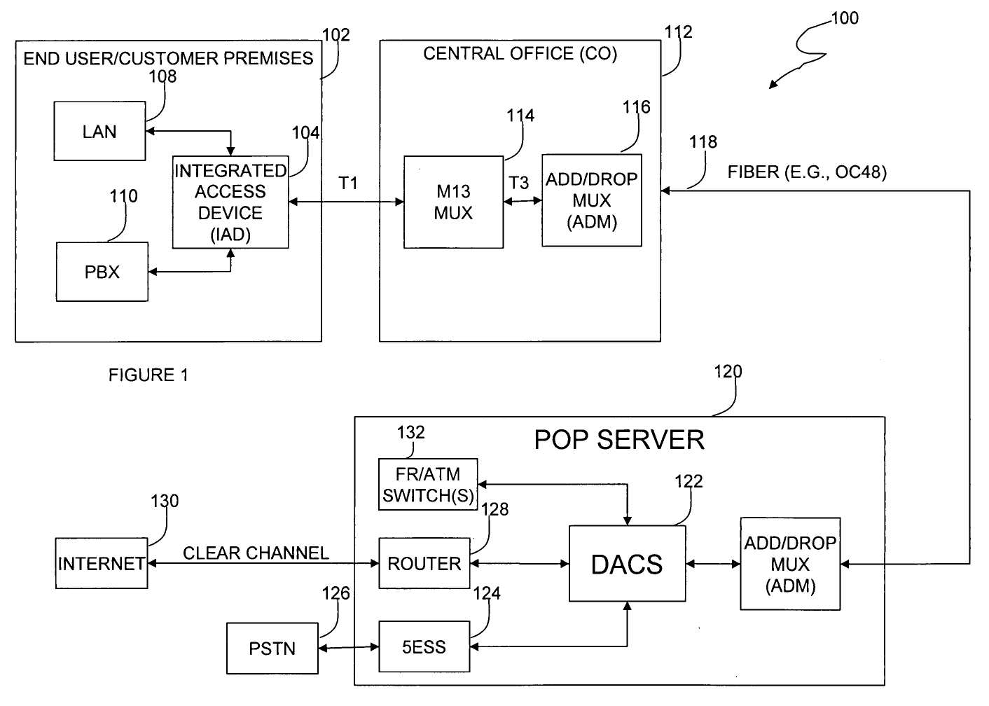

Referring now to FIG. 1, there is shown a system 100 in which an end user 102 (e.g., various sources at a customer premises(s)) communicates data to, for example, an integrated access device (IAD) 104 which can generally be understood herein to be a device that can aggregate multiple types of data and voice traffic from a customer premises 102 to a carrier network (e.g., FIG. 1, 106). It can be understood herein that a customer premises 102 can include, for example, a Local Area Network (LAN) 108 that can provide digital data in the form of packet data/protocol data units from one or more processor-controlled devices. Similarly, the customer premises 102 can include one or more Private Branch Exchanges (PBX) 110, that can provide analog and/or voice data in the form of time-division multiplexed (TDM) data to the IAD 104. The customer premises 102 can be associated herein with a “subscriber.” The illustrated IAD 104 can be, for example, a an Internet Protocol (IP) plus TDM voice IAD, a Frame Relay access device (FRAD) with TDM voice capability, and/or an Asynchronous Transfer Mode (ATM)-based IAD with TDM voice capability, although other types and/or configurations of IADs are contemplated by the disclosed methods and systems, with such examples provided for illustration and not limitation. Further, it is understood that for the various IADs, the TDM voice component may be absent and the Customer Premises Equipment (CPE) access devices may be all packet where some or all of the DS0s on the T1 are used for packets. Other CPE access devices may be TDM voice only where some or all of the DS0s are used for TDM voice.

In the FIG. 1 embodiment, the illustrated IAD 104 interfaces to a central office (CO) 112 via at least one T1 line 106. As provided herein, a “line” can be understood to be a communicative connection (wired and/or wireless) between two endpoints, where such connection may interrupted or uninterrupted; and, a CO can be understood to be a common carrier switching center in which trunks and loops (e.g., to customer premises (homes, businesses, etc.)) are terminated and/or switched, notwithstanding that other names can be associated with such locations and/or features. It can be understood that the disclosed methods and systems are not limited to a T1 line being received at the CO 112, and other lines, for example, a High-Bit-Rate Digital Subscriber Line (HDSL2) can additionally and/or optionally be received at the CO 112, with such example provided for illustration and not limitation.

In a typical example, an M13 Multiplexer (MUX) 114 receives between one and twenty-eight T1 lines 106 and maps, converts, and/or transfers the T1 lines 106 to a channelized T3 line that includes up to twenty-eight T1 lines 106. As the FIG. 1 embodiment shows, the channelized T3 line can interface to an Add/Drop MUX 116 that can transfer the channelized T3 line to fiber 118 before/upon exiting the CO 112, where the fiber 118 (e.g., OC3, OC48, etc. via a SONET network using one or more Add/Drop Multiplexers (ADMS) where the ADMs may add and/or drop a T3 at a site and/or node on the SONET network ring) can communicate with, for example, a Point-of-Presence Server (PoP) 120, although it can be understood that the connection between the fiber 118 and the PoP 120 may be direct or indirect, and can include, for example, other COs 112 that may provide additional T3 lines for inclusion in the communicative connection of the fiber 118. It can be understood that other communicative connections (e.g., non-fiber) are contemplated between a CO 112 and a PoP 120.

As shown in the FIG. 1 embodiment, the PoP 120 can receive the fiber 118 and can present such data to, for example an Add/Drop MUX (not shown) and/or a Digital (Access) Cross Connect System (DACS or DCCS) 122 which can generally be understood to be a device that can route T1 lines (e.g., the T1 lines of the channelized T3 lines), and thus, the DACS 122 can cross-connect a T1 line with another other T1 line also in the system. The illustrated DACS 122 can also be understood to connect a DS0 channel(s) on a T1 line to a DS0 time slot of another T1 line. More generally, the DACS 122 can be understood to organize the various mix of data on a T3 line, and can route such data accordingly, as is shown by the example embodiment of FIG. 1, in which TDM voice data (“non-packet data”) may be provided to, for example, a Class 5 Electronic Switching System (SESS) 124 which may then interface to the Public Switched Telephone Network (PSTN) 126. As the FIG. 1 embodiment also indicates, the illustrated DACS 122 may identify and/or aggregate concatenated DS0s containing protocol data units that may be IP packets, and provide such protocol data units to a router 102 that may route the various packets accordingly to the internet 130 using, for example, a clear channel line (e.g., an unchanneled T1 or T3 line). Additionally and/or optionally, Frame Relay (FR) and/or ATM packets may be transferred to a FR and/or ATM switch 132 for further routing/processing.

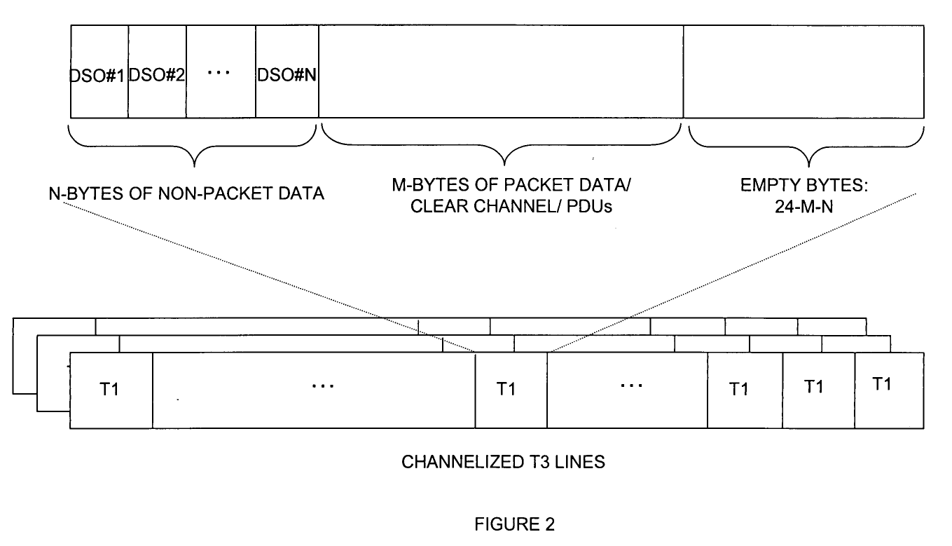

FIG. 2 shows one example of the channelized T3 lines 202 that provide connectivity between, for example, a CO 112 and a PoP 120. As FIGS. 1 and 2 illustrate, the channelized T3 includes as many as twenty-eight channels of T1 lines from subscribers/customer premises 102, where each T1 line includes twenty-four bytes. Of these twenty-four bytes, N bytes (e.g., 0<=N<=24) can be understood to include non-packet data (e.g., voice), while M bytes (e.g., 0<=M<=24−N) can be understood to include packets data/protocol data units. Accordingly, the remaining (24−M−N) bytes of the subscriber T1 line are empty and/or unused, and such empty bytes are provided in the corresponding channel of the channelized T3 line 202. As FIG. 2 illustrates, each of the twenty-eight channels of the channelized T3 line 202 may include T1s that have empty bytes/channels/DS0s, and thus, the channelized T3 can be underutilized. Because operating expenses associated with a channelized T3 between a CO 112 and a PoP 120 are based on the number of T3 lines, unused capacity in the T3 lines can be costly.

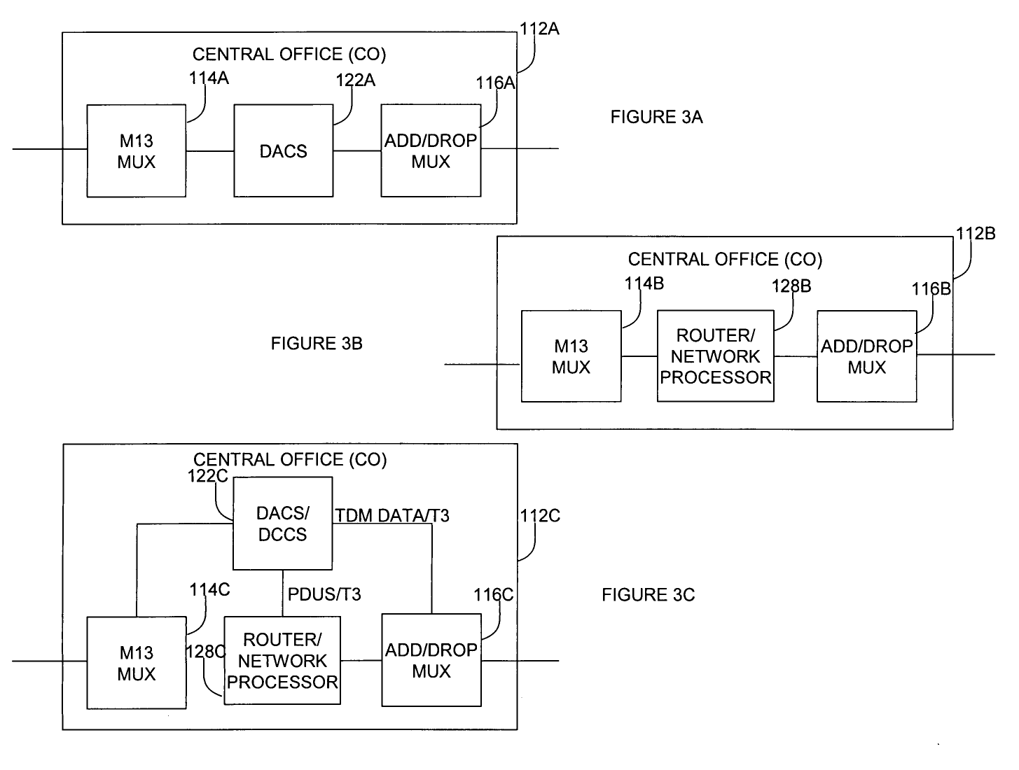

The disclosed methods and systems include a reduction of “trunk” T3 lines between a CO 112 and a PoP 120. In one embodiment shown in FIG. 3A, a CO 112A can be modified to include a DACS 122A to provide aggregation and/or routing of data prior to transmission of data from the CO 112A to the trunk (e.g., large-bandwidth channels between switching centers such as a CO 112 and a PoP 120, as compared to a “line” between a customer premises/subscriber 102 and a CO 112, for example), thereby reducing the traffic to the trunk. In an embodiment shown in FIG. 3B, a router 128B may be provided in the CO 112B to reduce the trunk capacity and/or bandwidth by statistically multiplexing packet data. In an embodiment illustrated in FIG. 3C, a CO 112C can include a DACS 122C and/or another device(s) (with the disclosed embodiments not limited to a DACS) that can identify data at the DS0 signal level to separate and/or aggregate, for example, non-packet data (e.g., TDM data) and packet data (e.g., protocol data units (PDUs)), and provide the packet data/protocol data units to a router 128C for processing, while providing the non-packet data/voice data on a separate channel. In one embodiment, for example, the DACS 122C and/or the router 128C can provide statistical multiplexing of the protocol data units, and/or provide a clear channel line.

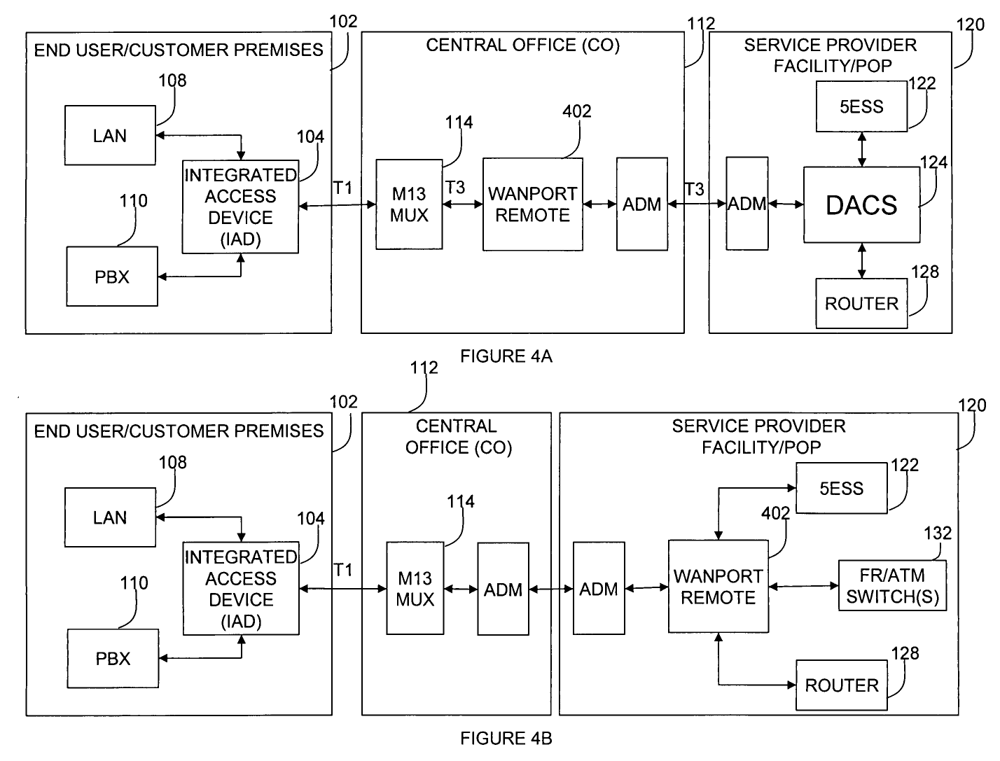

The disclosed methods and systems can thus combine, interchange, separate, and/or otherwise reconfigure the components and/or features of the DACS 122C and the router 128C of the FIG. 3C embodiment. For example, in an embodiment shown in FIG. 4A, a “WANport Remote” 402 is shown as provided in a CO 112 such that the illustrated WANport Remote 402 can be understood to be capable of receiving one or more channelized T3 lines, where the channelized T3 line is based on one or more signal lines that include packet and/or non-packet data from one or more end users/subscribers (e.g., a channelized T3 line from a M13 MUX 114). The WANport Remote can thus provide, as an output, one or more T3 lines. Providing the T3 lines as output thus includes an aggregating and/or transmitting of the non-packet data on one or more channelized lines, which can be a channelized trunk T3 line, and further, aggregating and/or transmitting the packet data on at least one clear channel line. The clear channel line can also include a T3 line that may be the same T3 line as the channelized trunk T3 line, and/or a different T3 line. In a case where the channelized TDM and the packet data are on the same T3, packet data can use a subset of the 28 T1s in a Multilink Frame Relay/MLPPP configuration, with each of the packet T1 streams identified by a DLCI.

The illustrated WANport Remote 402 can thus be understood to accept as input and/or receive one or more T3 lines that include packet data/protocol data units and/or non-packet data (e.g., TDM voice). The WANport Remote 402 can identify Digital Signal Zero (DS0) signals that include the packet data and DS0 signals that include the non-packet data, cross-connect the non-packet data to at least one channelized line, and, transmitting the packet data to a network processor(s) that may be separate from, and/or part of, the WANport Remote 402. The packet data/protocol data units can be statistically multiplexed and otherwise transmitted or provided on a clear channel line that can include a multilink bundle. Further, the WANport Remote 402 can provide the non-packet data (e.g., TDM voice data) from the T3 lines to one or more channelized lines, which can be a T3 line. It can be understood that by identifying the DS0 signals which include packet and non-packet data, the WANport Remote 402 also identifies DS0 signals/channels which do not include data. As provided herein, by eliminating unused and/or empty DS0 signals/channels, and otherwise aggregating non-empty DS0 signals/channels, fewer T1 lines, and hence fewer T3 lines, may be needed.

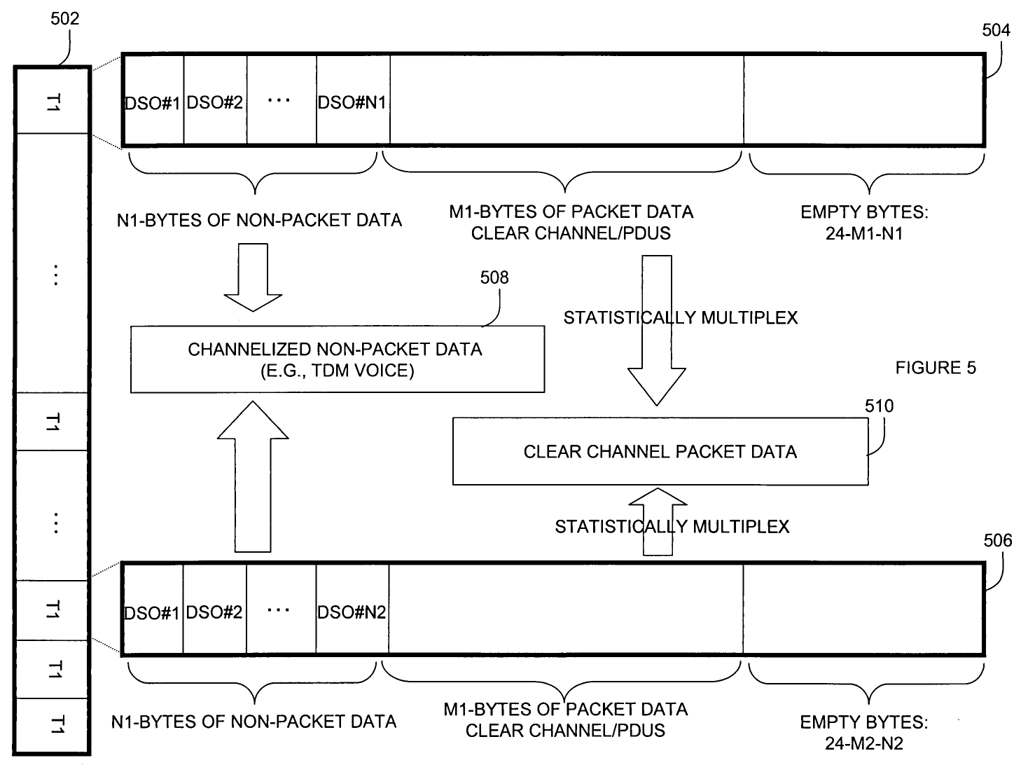

FIG. 5 shows some of the features of the illustrated WANport Remote 402. As shown in FIG. 5, a received channelized T3 line 502 to the WANport Remote 402 can include as many as twenty-eight T1 lines, although it can be understood that more than one channelized T3 line can be received. FIG. 5 illustrates two of such T1 lines 504, 506, where such T1 lines include up to 24 bytes of data, which can include, for example, N bytes of non-packet data (e.g., TDM voice data) and M bytes of packet data/clear channel/protocol data units. Accordingly, the remaining (24−M−N) bytes of each T1 line is empty. As provided herein, the disclosed methods and systems identify at the DS0 level, those DS0 signals that are packet data, non-packet data, and empty. For example, FIG. 5 illustrates a first T1 line 504 having N1 non-packet bytes, M1 bytes of packet data, and (24−M1−N1) bytes empty, and, a second T1 line 506 having N2 non-packet bytes, M2 bytes of packet data, and (24−M2−N2) bytes empty. The disclosed methods and systems include hardware and/or software, including for example, processor instructions, to aggregate the non-packet data from the various T1 lines (e.g., N1 bytes from 504, . . . , N2 bytes from 506, . . . ) and to map such non-packet data to a channelized line 508. In one example, the channelized line can include a channelized T3 line. Further, the disclosed methods and systems include hardware and/or software, including for example, processor instructions, to aggregate the packet data/protocol data units from the various T3 lines and to statistically multiplex the packet data to a clear channel line 510, which may include, as shown in the FIG. 5 embodiment, a clear channel T3 line. It can be understood that the channelized line 508 and the clear channel line 510 may be the same T3 line and/or different lines, where such determination maybe based on the number of non-packet bytes and/or number of packet bytes included in the received channelized T3 line(s) 502. It can further be understood that the channelized line 508 and the clear channel line 510 can include data from more than one channelized T3 line 502, based on the amount of empty data (e.g., empty DS0s) in the various channelized T3 lines 502.

For example, with reference to FIG. 4A and FIG. 5, consider a subscriber(s) providing eight channelized T3 lines from an M13 Mux 114 to a WANport Remote 402 and/or other device(s) that is capable of performing the methods and systems attributed herein to the WANport Remote 402, referred to collectively herein as the WANport Remote. As known in the art, each channelized T3 includes twenty-eight T1 subscribers, providing a total of two hundred twenty-four T1 subscribers. Each T1 subscriber further includes eight TDM voice channels (e.g., eight bytes of TDM voice data/non-packet data), with the remaining bytes (e.g., sixteen bytes) including packetized Internet access data. Under such an illustrative scenario, a total number of non-packet (e.g., TDM voice) data can be determined to be: (8 channelized T3)×(28 T1 channels/T3)×(8 bytes (channels)/T1)=1792 bytes (channels) of non-packet (e.g., voice) data. Further, because a single T3 line includes: (28 T1 channels/T3)×(24 channels/T1)=672 bytes (channels), 3 T3 lines or 2016 channels are needed at the “trunk” side of the WANport Remote 402 for the non-packet data. Further, the packetized Internet data can be statistically multiplexed onto a separate clear channel T3 line and/or multilink bundled (e.g., Multilink Point-to Point Protocol (PPP)) as clear channel data to one of the three aforementioned T3 lines that are otherwise not fully occupied with TDM voice data and/or other non-packet data. Accordingly, the eight T3 lines received by the WANport Remote are reduced to three or four T3 lines through aggregation of the non-packet data and packet data, and further, through statistical multiplexing of the packet data/protocol data units. Such a reduction in T3 bandwidth can reduce operating expenses.

It can be understood that the aggregated data is not limited to T3 line data, and can be provided on ETHERNET, including Gigabit ETHERNET and/or SONET.

The disclosed methods and systems, including the features of the example WANport Remote 402 device(s), can include transmitting the non-packet data onto a Trunk T3. It can also be understood that a user and/or another can configure the WANport Remote 402 (e.g., via a user interface such as CLI, TL1, etc.) to cross-connect packet data (e.g., IP data, concatenated DS0s of a FR/ATM stream, etc.). For example, concatenated DS0s of a FR packet stream and/or concatentated DS0s of an ATM cell packet stream can be mapped (e.g., cross-connected) to a single T1 provided the number of aforementioned concatenated DS0s (FR and ATM) does not exceed the capacity of a single T1 (e.g., twenty-four DS0s). It can be thus be understood that the disclosed methods and systems can provide for concatenated DS0s that contain packet/cell data yet are not configured to be statistically multiplexed, can be cross-connected, with it being understood that if a T1 line includes a clock signal, the concatenated group remains on the same T1 line to assure that the same clock is used across the group of DS0s representing a single stream of packets or cells. Accordingly, the disclosed methods and system include identifying whether a clock signal is present.

In some embodiments, it can thus be understood that a user and/or another can configure the DS0s by identifying DS0s (e.g., packet data) which are to be sent to a Network Processor to be statistically multiplexed (and hence transmitted via a clear channel line), with other/remaining DS0s (packet and/or non-packet data) being configured for cross-connecting (subject to the aforementioned clocking issue).

As provided herein, if a (trunk) T3 line is not filled with non-packet data, the remaining T1 lines can be used in a multilink bundle for packet (protocol data unit) traffic/data.

FR, IP, HDLC, and/or Multi-link PPP (MLPPP) packets may thus be switched, or terminated and forwarded to a network processor(s) as IP packets. If a FR packet is switched by the WANport Remote 402, the Data Link Channel Identifier (DLCI) on the received T1 can be mapped to DLCI on a trunk T3 where such T3 DLCI is unique on that T3. Further, if FR, IP, HDLC, and/or MLPPP is terminated and forwarded as IP packets, a unique Trunk T3 DLCI can be used to identify a single stream of packets on a DS0, nxDS0, T1, and/or multiple T1s (rather than a VLAN tag). In one embodiment, packets can be forwarded based on the methods and systems disclosed in pending U.S. patent application Ser. No. 10/012,905, filed on Nov. 13, 2001, entitled “Channeling Protocol Data Units,” the entirety of which is incorporated herein by reference in its entirety.

U.S. Ser. No. 10/012,905 discloses, in general, methods of channeling a protocol data unit that include receiving a protocol data unit having a label, accessing data identifying a channel associated with the label, and transmitting the protocol data unit via the identified channel. The protocol data unit may include a destination address. The protocol data unit may be an IP (Internet Protocol) packet. The label may be an MPLS (Multi-Protocol Label Switching) Label, a VLAN (Virtual LAN) tag, or a GMPLS (Generalized MPLS) label. The method may include establishing the label with a network router, for example, by requesting a label for messages transmitted from a downstream entity to the router. Establishing the label may also include sending data (e.g., a ping, ICMP Echo Message, or TCP or UDP datagram) to the router destined for the downstream entity. The method can include stripping the label from the protocol data unit before the transmitting of the protocol data unit via the identified channel. The method can also include storing data in a table that associates different labels with different respective channels. The identified channel may be a channel of an nxDS0 carrier, a DS1 carrier, a DS3 carrier, a subrate DS3 carrier, and/or a SONET carrier. The method may further include dechannelizing a protocol data unit received via incoming channels and, potentially, forwarding each dechannelized protocol data unit to the same router. Accordingly, in one embodiment, disclosed is a method of channeling an Internet Protocol (IP) packet that includes requesting a first MPLS (Multi-Protocol Label Switching) label from a network router for delivery of messages from a downstream entity to the router, sending a message to the router destined for the downstream entity, receiving, in response to the message, a request from the router for a second MPLS label for delivery of messages to the downstream entity, and, storing data associating the second MPLS label with identification of a channel of a channelized carrier servicing the downstream entity. The disclosed methods also includes receiving the Internet Protocol packet from the network router, the packet having the second MPLS label and a destination address; identifying the channel associated with the second MPLS label, stripping the label from the packet; and transmitting the packet via the identified channel. The method also includes dechannelizing a packet received from the downstream entity via the identified channel and forwarding the dechannelized packet to the router. It can be understood that there may be other methods and/or systems for identifying and/or receiving a MPLS label, and thus, the examples provided herein are for illustration and not limitation.

Returning to FIGS. 4A and 5, the illustrated WANport Remote 402 can thus also aggregate and/or forward PPP and High Level Data Link Control (HDLC) packets on Trunk T3s using DLCI to identify T1 and/or T1 bundles.

Further, as provided previously herein, FR and/or IP packets can be identified and/or aggregated and transmitted clear channel on a Trunk T3 line and/or on FR Multilink bundles of less than twenty-eight T1 lines. If FR Multilink is used, the remaining T1 lines can be used for TDM traffic and/or another FR Multilink bundle. It can thus be understood, as provided herein, that the disclosed methods and systems (e.g., WANPort Remote 402) can include multiplexing packet data at Open Systems Interconnection (OSI) layer 2 onto a clear channel line (e.g., T3) using FR and/or onto a group of less than twenty-eight T1 lines using Multilink FR, which, when combined with statistical multiplexing, allows for fewer T3 lines when compared to systems that multiplex packet data onto channelized lines (e.g., T3s).

The disclosed methods and systems can additionally and/or optionally allow for packet data to be multiplexed onto ETHERNET (e.g., GigE) for backhaul as provided herein, using the methods and systems described in U.S. Ser. No. 10/012,905. In embodiments, VLAN tags on the GigE can be mapped to unique DLCI on FR multilink bundles and/or clear channel lines (e.g., Trunk T3 lines). In embodiments where a carrier may offer an ETHERNET service, a separate backhaul network may thus not be required, as the disclosed methods and systems (e.g., WANPort Remote 402) can include an ETHERNET interface and allow for multiplexing of ETHERNET packets onto an existing FR and/or ETHERNET backhaul (using FR and/or MLFR and/or ETHERNET) disclosed herein, which provides further for statistical multiplexing. It can be understood that such a feature can be provided by eliminating an ETHERNET header from the subscriber and multiplexing the packet data with other T1 from the backhaul and sending as an ETHERNET packet, and/or encapsulating ETHERNET subscriber packets in a FR packet on the backhaul and demultiplexing to an ETHERNET interface at the PoP server, and/or using MPLS Pseudo Wire Emulation Edge to Edge (PWE3) (e.g., encapsulate PPP, HDLC, ETHERNET, etc., over MPLS and/or IP).

In an embodiment illustrated in FIG. 4B, a WANport Remote 402 can be provided at a PoP 120. As indicated with respect to the embodiment of FIG. 4A, trunk T3 can be received by the FIG. 4B WANport Remote 402 in the same manner as the “channelized T3 lines” were received in the FIG. 4A embodiment, and thus data from the trunk T3 lines can be characterized as non-packet data, packet data, or empty. The packet data can be provided and/or transmitted to a first channelized line, whereas packet data can be statistically multiplexed on a clear channel line. As indicated in FIG. 4B, the packet data can be provided to a FR Switch and/or an ATM switch 132, while some packet data can be provided to a network processor/router 128. As FIG. 4B also indicates, a channelized line may include only non-packet data (e.g., TDM voice), and such a channelized line (e.g., TDM T3 line) can be connected to a 5ESS switch 122.

It can thus be understood that the disclosed methods and systems, which include the WANport Remote 402, can include a user interface such as a command line interface (CLI) and/or a Telecom Management Protocol (TL1) that can allow a user and/or another to specify the cross-connections of the incoming T3s and outgoing lines. The methods and systems can thus allow for a provisioning of an IAD 104 (e.g., FIG. 1). The disclosed WANport Remote 402 can further provide a capability to maintain robbed-bit signaling, process transparent T1, and provide other features such as redundant power, clock stability, and/or alarm capabilities.

What has thus been described are methods, systems, and processor programs for receiving at least one channelized T3 line, where the channelized T3 line is based on at least one communications line including packet data and/or non-packet data from at least one end user, identifying Digital Signal Zero (DS0) signals that include the packet data and DS0 signals that include the non-packet data, cross-connecting the non-packet data to at least one channelized line, and, transmitting at least some of the packet data to at least one network processor, e.g., for forwarding on a clear channel and/or in a multilink bundle.

The methods and systems described herein are not limited to a particular hardware or software configuration, and may find applicability in many computing or processing environments. The methods and systems can be implemented in hardware or software, or a combination of hardware and software. The methods and systems can be implemented in one or more computer programs, where a computer program can be understood to include one or more processor executable instructions. The computer program(s) can execute on one or more programmable processors, and can be stored on one or more storage medium readable by the processor (including volatile and non-volatile memory and/or storage elements), one or more input devices, and/or one or more output devices. The processor thus can access one or more input devices to obtain input data, and can access one or more output devices to communicate output data. The input and/or output devices can include one or more of the following: Random Access Memory (RAM), Redundant Array of Independent Disks (RAID), floppy drive, CD, DVD, magnetic disk, internal hard drive, external hard drive, memory stick, or other storage device capable of being accessed by a processor as provided herein, where such aforementioned examples are not exhaustive, and are for illustration and not limitation.

The computer program(s) can be implemented using one or more high level procedural or object-oriented programming languages to communicate with a computer system; however, the program(s) can be implemented in assembly or machine language, if desired. The language can be compiled or interpreted.

As provided herein, the processor(s) can thus be embedded in one or more devices that can be operated independently or together in a networked environment, where the network can include, for example, a Local Area Network (LAN), wide area network (WAN), and/or can include an intranet and/or the internet and/or another network. The network(s) can be wired or wireless or a combination thereof and can use one or more communications protocols to facilitate communications between the different processors. The processors can be configured for distributed processing and can utilize, in some embodiments, a client-server model as needed. Accordingly, the methods and systems can utilize multiple processors and/or processor devices, and the processor instructions can be divided amongst such single or multiple processor/devices.

The device(s) or computer systems that integrate with the processor(s) can include, for example, a personal computer(s), workstation (e.g., Sun, HP), personal digital assistant (PDA), handheld device such as cellular telephone, laptop, handheld, or another device capable of being integrated with a processor(s) that can operate as provided herein. Accordingly, the devices provided herein are not exhaustive and are provided for illustration and not limitation.

References to “a microprocessor” and “a processor”, or “the microprocessor” and “the processor,” can be understood to include one or more microprocessors that can communicate in a stand-alone and/or a distributed environment(s), and can thus can be configured to communicate via wired or wireless communications with other processors, where such one or more processor can be configured to operate on one or more processor-controlled devices that can be similar or different devices. Use of such “microprocessor” or “processor” terminology can thus also be understood to include a central processing unit, an arithmetic logic unit, an application-specific integrated circuit (IC), and/or a task engine, with such examples provided for illustration and not limitation.

Furthermore, references to memory, unless otherwise specified, can include one or more processor-readable and accessible memory elements and/or components that can be internal to the processor-controlled device, external to the processor-controlled device, and/or can be accessed via a wired or wireless network using a variety of communications protocols, and unless otherwise specified, can be arranged to include a combination of external and internal memory devices, where such memory can be contiguous and/or partitioned based on the application. Accordingly, references to a database can be understood to include one or more memory associations, where such references can include commercially available database products (e.g., SQL, Informix, Oracle) and also proprietary databases, and may also include other structures for associating memory such as links, queues, graphs, trees, with such structures provided for illustration and not limitation.

References to a network, unless provided otherwise, can include one or more intranets and/or the internet. References herein to microprocessor instructions or microprocessor-executable instructions, in accordance with the above, can be understood to include programmable hardware.

Unless otherwise stated, use of the word “substantially” can be construed to include a precise relationship, condition, arrangement, orientation, and/or other characteristic, and deviations thereof as understood by one of ordinary skill in the art, to the extent that such deviations do not materially affect the disclosed methods and systems.

Throughout the entirety of the present disclosure, use of the articles “a” or “an” to modify a noun can be understood to be used for convenience and to include one, or more than one of the modified noun, unless otherwise specifically stated.

Elements, components, modules, and/or parts thereof that are described and/or otherwise portrayed through the figures to communicate with, be associated with, and/or be based on, something else, can be understood to so communicate, be associated with, and or be based on in a direct and/or indirect manner, unless otherwise stipulated herein.

Although the methods and systems have been described relative to a specific embodiment thereof, they are not so limited. Obviously many modifications and variations may become apparent in light of the above teachings. For example, although the methods and systems (and/or processor programs) referred to the WANport Remote 402, it can be understood that such reference is for convenience, and such device can be otherwise configured (e.g., separated, combined, etc.) with other devices, such as, for example a router and/or a network processor. Further, references herein to a network processor can include the features provided by a router, but are not limited thereto, and can include other processors that perform the features attributed herein to the described network processor. Although the methods and systems refer to cross-connecting non-packet data, it can be understood that packet data can also be cross-connected.

Many additional changes in the details, materials, and arrangement of parts, herein described and illustrated, can be made by those skilled in the art. Accordingly, it will be understood that the following claims are not to be limited to the embodiments disclosed herein, can include practices otherwise than specifically described, and are to be interpreted as broadly as allowed under the law.

1. A method, comprising:
receiving at least one channelized T3 line, where the channelized T3 line is based on at least one communications line including at least one of packet data and non-packet data from at least one end user,
identifying Digital Signal Zero (DS0) signals that include the packet data and DS0 signals that include the non-packet data,
cross-connecting the non-packet data to at least one channelized line, and,
transmitting at least some of the packet data to at least one network processor.

2. A method according to claim 1, where the at least one network processor statistically multiplexes the packet data.

3. A method according to claim 2, where the at least one network processor transmits the statistically multiplexed packet data using at least one clear channel line.

4. A method according to claim 3, where the at least one clear channel line includes a T3 line.

5. A method according to claim 4, where the T3 line includes the at least one T3 line that includes the cross-connected data.

6. A method according to claim 3, where the at least one clear channel line includes SONET.

7. A method according to claim 3, where the at least one clear channel line includes ETHERNET.

8. A method according to claim 2, where the at least one network processor transmits the statistically multiplexed packet data using at least one multilink bundle.

9. A method according to claim 8, where the cross-connected data and the at least one multilink bundle reside on at least one T3 line.

10. A method according to claim 1, where the at least one clear channel line includes a multilink bundle.

11. A method according to claim 1, where the at least one channelized line includes a T3 line.

12. A method according to claim 1, where the at least one channelized line includes SONET.

13. A method according to claim 1, where the at least one channelized line includes a multilink bundle.

14. A method according to claim 1, further comprising:
cross-connecting at least some of the packet data to a single T1 line.

15. A method according to claim 15, where the cross-connected packet data includes at least one of: concatenated DS0 FR data, IP Packet data, and concatenated DS0 ATM cell data.

16. A method according to claim 15, where cross-connecting includes:
identifying less than twenty-five DS0s having at least one of FR data and ATM data, and,
cross-connecting the identified DS0s to the single T1 line.

17. A method according to claim 1, where the at least one network processor statically maps a protocol data unit based on a Data Link Channel Identifier (DLCI).

18. A method according to claim 1, where the at least one network processor maps a protocol data unit based on a Virtual Local Area Network (VLAN) tag.

19. A method according to claim 1, where the at least one network processor statically maps a protocol data unit based on Multiprotocol Label Switching (MPLS).

20. A method according to claim 1, where the at least one network processor:
receives a protocol data unit having a label,
accesses data identifying a channel associated with the label, and
transmits the protocol data unit via the identified channel.

21. A method according to claim 20, where the label includes at least one of: an MPLS (Multi-Protocol Label Switching) label, a VLAN (Virtual Local Area Network) tag, and a GMPLS (Generalized MPLS) label.

22. A method according to claim 20, further comprising establishing the label with a network router.

23. A method according to claim 22, where establishing the label with the network router includes requesting a label for the messages transmitted from a downstream entity to the router.

24. A method according to claim 23, where establishing the label includes sending data to a router destined for the downstream entity.

25. A method according to claim 1, where the at least one network processor:
receives at least one input from a Gigabit ETHERNET line (GigE), and,
maps the data on the GigE to the at least one clear channel line based on VLAN tags.

26. A method according to claim 25, where mapping the data on the GigE includes multiplexing the data on the GigE with the packet data.

27. A method according to claim 1, where the at least one network processor:
receives at least one input from a Gigabit ETHERNET line (GigE), and,
maps the data on the GigE using at least one of: Frame Relay (FR), Multi-Link Frame Relay (MLFR), and ETHERNET.

28. A method according to claim 1, where the receiving, identifying, cross-connecting, and transmitting occur at a central office.

29. A method according to claim 1, where the receiving, identifying, cross-connecting, and transmitting occur at a point-of-presence server.

30. A method according to claim 1, where identifying Digital Signal Zero (DS0) signals that include the packet data and DS0 signals that include the non-packet data includes identifying empty DS0 signals.

31. A method according to claim 1, where identifying Digital Signal Zero (DS0) signals that include the packet data and DS0 signals that include the non-packet data includes identifying based on provisioning of an Integrated Access Device (IAD).

32. A method according to claim 1, where cross-connecting includes using at least one of: Telecom Management Protocol (TL1) and Command Line Interface (CLI).

33. A method according to claim 1, where cross-connecting includes preserving robbed-bit signaling.

34. A system, comprising:
a user interface to specify cross-connections of DS0 signals,
at least one T3 line interface, the T3 line interface providing DS0 signals that include at least one of packet data and non-packet data from at least one end user,
a cross-connector to cross-connect the specified DS0 signals to at least one channelized line, and,
at least one network processor to receive the non-cross-connected DS0 signals.

35. A system according to claim 34, where the at least one network processor includes processor instructions for statistically multiplexing the received data.

36. A system according to claim 34, where the system includes at least one of: an interface to an Add/Drop multiplexer and an Add/Drop multiplexer.

37. A system according to claim 34, where the system includes at least one ETHERNET interface.

38. A system according to claim 34, where the user interface includes at least one of: Telecom Management Protocol (TL1) and Command Line Interface (CLI).

39. A system according to claim 34, where the at least one network processor includes instructions to transmit the received data using at least one clear channel line.

40. A system according to claim 39, where the at least one clear channel line includes a T3 line.

41. A system according to claim 40, where the T3 line includes the cross-connected data.

42. A system according to claim 39, where the at least one clear channel line includes SONET.

43. A system according to claim 39, where the at least one clear channel line includes ETHERNET.

44. A system according to claim 34, further including at least one router.
